(19) United States
(12) Patent Application Publication
(10) Pub. No.: US 2010/0197743 A1
(43) Pub. Date: Aug. 5, 2010

(54) Use of sulphur-containing heteroaromatic acid analogues

(75) Inventors: Karl-Wilhelm Münks, Meerbusch (DE); Peter Howard Davies, Muntinlupa City (PH); Akihisa Oshima, Muntinlupa City (PH)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/588,057

(22) Filed: Oct. 1, 2009

(30) Foreign Application Priority Data
Oct. 2, 2008 (EP) 08165765.2
Dec. 19, 2008 (EP) 08172324.9
Jan. 30, 2009 (EP) 09151742.5

(51) Int. Cl. A01N 43/828; A01N 43/80; A01P 1/00; A01P 3/00

(52) U.S. Cl. 514/361; 514/372

(57) ABSTRACT

The present invention relates to the use of compounds according to formula (I)

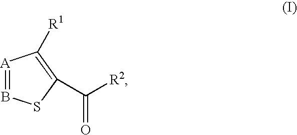

for controlling microbial and animal pathogens in plants of the Musaceae family.

Furthermore, the present invention relates to a method of controlling microbial and animal pathogens in plants of the Musaceae family by treating them with compounds according to formula (I).

The present invention relates to the use of compounds according to formula (I)

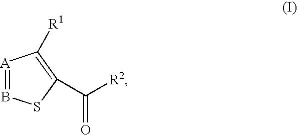

where
A is nitrogen or C-Hal,
B is nitrogen or C-Hal,
R¹ is hydrogen, halogen, cyano, C₁-C₆-alkyl, C₂-C₆-alkenyl, C₃-C₆-cycloalkyl, phenyl, C₁-C₆-alkyl which is substituted by Hal or cyano, C₂-C₆-alkenyl which is substituted by Hal or cyano, C₃-C₆-cycloalkyl which is substituted by Hal or cyano, or phenyl which is substituted by cyano, halogen, alkoxy,
R² is hydroxyl, C₁-C₆-thioalkyl, C₁-C₆-aminoalkyl, C₁-C₆-alkoxy, phenoxy, aniline,
or is C₁-C₆-alkoxy which is substituted by cyano, halogen, C₁-C₆-alkyl, C₁-C₆-alkoxy and/or C₁-C₆-alkylcarbonyl,
or is phenoxy which is substituted by cyano, halogen, C₁-C₆-alkoxy, C₁-C₆-alkylamino, C₁-C₆-alkylcarbonyl, formyl, C₁-C₆-alkyl, C₁-C₆-alkoxy, C₁-C₆-alkylcarbonyl and/or C₁-C₆-alkoxycarbonyl or is aniline which is substituted by cyano, halogen, C₁-C₆-alkyl, C₁-C₆-alkoxy, C₁-C₆-alkylamino, C₁-C₆-dialkylamino and/or C₁-C₆-alkylcarbonyl,
   Hal is halogen,
   for controlling microbial and animal pathogens in plants of the Musaceae family.

Furthermore, the present invention relates to a method of controlling microbial and animal pathogens in plants of the Musaceae family by treating them with compounds according to formula (I).

The compounds of formula (I) are known from WO 99/024 413, WO 2006/098128, JP 2007-84566 and WO 96/29871, inter alia.

Preferred compounds of the formula (I) are those in which

A is C-Hal or nitrogen,
B is nitrogen,
R¹ is halogen, C₁-C₆-alkyl, C₂-C₆-alkenyl, C₃-C₆-cycloalkyl,
R² is hydroxyl, C₁-C₆-thioalkyl, C₁-C₆-aminoalkyl, C₁-C₆-alkoxy, phenoxy, aniline,
or is C₁-C₆-alkoxy which is substituted by cyano, halogen, C₁-C₆-alkyl, C₁-C₆-alkoxy, C₁-C₆-alkylcarbonyl,
or is phenoxy which is substituted by cyano, halogen, C₁-C₆-alkoxy, C₁-C₆-alkylamino, C₁-C₆-alkylcarbonyl, formyl, C₁-C₆-alkyl, C₁-C₆-alkoxy, C₁-C₆-alkylcarbonyl and/or C₁-C₆-alkoxycarbonyl, or
is aniline which is substituted by cyano, halogen, C₁-C₆-alkyl, C₁-C₆-alkoxy, C₁-C₆-alkylamino, C₁-C₆-dialkylamino and/or C₁-C₆-alkylcarbonyl,
   Hal is fluorine, chlorine or bromine.

Especially preferred compounds according to formula (I) are those in which Hal is chlorine or bromine.

Especially preferred compounds according to formula (I) are those in which Hal is chlorine.

Especially preferred compounds according to formula (I) are those in which A is C-Hal or nitrogen and B is nitrogen.

Especially preferred compounds according to formula (I) are those in which A is C-Hal and B is nitrogen.

Especially preferred compounds according to formula (I) are those in which A is nitrogen and B is nitrogen.

Especially preferred compounds according to formula (I) are those in which A is nitrogen and B is nitrogen, and R¹ is cyclopropyl and R² is aniline, or is aniline which is substituted by cyano, halogen, C₁-C₆-alkyl, C₁-C₆-alkoxy, C₁-C₆-alkylamino, C₁-C₆-dialkylamino and/or C₁-C₆-alkylcarbonyl.

Especially preferred compounds according to formula (I) are those in which A is C-Hal or nitrogen and B is nitrogen, and R² is aniline, or is aniline which is substituted by cyano, halogen, C₁-C₆-alkyl, C₁-C₆-alkoxy, C₁-C₆-alkylamino, C₁-C₆-dialkylamino and/or C₁-C₆-alkylcarbonyl.

Especially preferred compounds according to formula (I) are those in which A is C-Hal or nitrogen and B is nitrogen, and R² is hydroxyl.

Especially preferred compounds according to formula (I) are those in which A is nitrogen and B is nitrogen, and R² is hydroxyl.

Especially preferred compounds according to formula (I) are those in which A is C-Hal or nitrogen and B is nitrogen, and R² is C₁-C₆-thioalkyl.

Especially preferred compounds according to formula (I) are those in which A is C-Hal or nitrogen and B is nitrogen, and R² is C₁-C₆-alkoxy.

Especially preferred compounds according to formula (I) are those as shown in Table 1.

TABLE 1

| No | A | B | R¹ | R² | Hal |
|---|---|---|---|---|---|
| I-1 | N | N | CH₃ | 3-Chloro-4- | — |
| | | | | methylaniline | |
| I-2 | C-Hal | N | Cl | 2-Cyanoaniline | Cl |
| I-3 | N | N | CH₃ | OH | — |
| I-4 | C-Hal | N | Cl | OH | Cl |
| I-5 | N | N | Cyclopropyl | 3-Chloro-4- | — |
| | | | | methylaniline | |
| I-6 | N | N | CH₃ | Methoxy | — |
| I-7 | N | N | CH₃ | Thiomethyl | — |
| I-8 | N | N | CH₃ | 2-Cyanoaniline | — |
| I-9 | N | N | Cyclopropyl | OH | — |
| I-10 | N | N | Cyclopropyl | Methoxy | — |
| I-11 | N | N | Cyclopropyl | Thiomethyl | — |
| I-12 | N | N | Cyclopropyl | 2-Cyanoaniline | — |
| I-13 | C-Hal | N | Cl | 3-Chloro-4- | Cl |
| | | | | methylaniline | |
| I-14 | C-Hal | N | Cl | Methoxy | Cl |
| I-15 | C-Hal | N | Cl | Thiomethyl | Cl |
| I-16 | C-Hal | N | CH₃ | 3-Chloro-4- | Cl |
| | | | | methylaniline | |
| I-17 | C-Hal | N | CH₃ | OH | Cl |
| I-18 | C-Hal | N | CH₃ | Methoxy | Cl |
| I-19 | C-Hal | N | CH₃ | Thiomethyl | Cl |
| I-20 | C-Hal | N | CH₃ | 2-Cyanoaniline | Cl |

(C₁-C₆)-Alkyl represents a straight-chain or branched alkyl radical having 1 to 6 carbon atoms. Preferred is a straight-chain or branched alkyl radical having 1 to 4, especially preferably having 1 to 3, carbon atoms. The following may be mentioned by way of example and by preference: methyl, ethyl, n-propyl, isopropyl, tert-butyl, n-pentyl and n-hexyl.

Halogen represents fluorine, chlorine, bromine and iodine. Preferred are fluorine, chlorine and bromine. Especially preferred are bromine and chlorine.

(C₃-C₆)-Cycloalkyl represents cyclopropyl, cyclopentyl, cyclobutyl or cyclohexyl. Preferred are cyclopropyl, cyclopentyl and cyclohexyl. Especially preferred is cyclopropyl.

(C₂-C₆)-Alkenyl represents a straight-chain or branched alkenyl radical having 2 to 6 carbon atoms. Preferred is a straight-chain or branched alkenyl radical having 2 to 4, especially preferably having 2 to 3, carbon atoms. The following may be mentioned by way of example and by preference: vinyl, allyl, n-prop-1-en-1-yl and n-but-2-en-1-yl.

(C₁-C₆)-Alkoxy represents a straight-chain or branched alkoxy radical having 1 to 6 carbon atoms. Preferred is a straight-chain or branched alkoxy radical having 1 to 4, especially preferably having 1 to 3, carbon atoms. The following may be mentioned by way of example and by preference: methoxy, ethoxy, n-propoxy, isopropoxy, tert-butoxy, n-pentoxy and n-hexoxy.

(C₁-C₆)-Alkoxycarbonyl represents a straight-chain or branched alkoxycarbonyl radical having 1 to 6 carbon atoms. Preferred is a straight-chain or branched alkoxycarbonyl radical having 1 to 4, especially preferably having 1 to 3, carbon atoms. The following may be mentioned by way of example and by preference: methoxycarbonyl, ethoxycarbonyl, n-propoxycarbonyl, isopropoxycarbonyl and tert-butoxycarbonyl.

(C₁-C₆)-Alkylcarbonyl represents a straight-chain or branched alkylcarbonyl radical having 1 to 6 carbon atoms. Preferred is a straight-chain or branched alkylcarbonyl radical having 1 to 4, especially preferably having 1 to 3, carbon atoms. The following may be mentioned by way of example and by preference: methylcarbonyl, ethylcarbonyl, n-propylcarbonyl, isopropylcarbonyl and tert-butylcarbonyl.

The definitions of radicals or explanations which have been mentioned above in general terms or in preferred ranges may be combined as desired between the respective ranges and preferred ranges.

### INVENTION

It has now been found that the compounds according to formula (I) are particularly suitable for controlling microbial and animal pathogens on plants of the Musaceae family.

A first subject matter of the invention is therefore the use of a compound selected from the compounds according to formula (I) for controlling microbial and animal pathogens in plants of the Musaceae family.

A further subject matter of the invention is therefore the use of compound I-1 for controlling microbial and animal pathogens in plants of the Musaceae family.

A further subject matter of the invention is therefore the use of compound I-2 for controlling microbial and animal pathogens in plants of the Musaceae family.

A further subject matter of the invention is therefore the use of compound I-3 for controlling microbial and animal pathogens in plants of the Musaceae family.

A further subject matter of the invention is therefore the use of compound I-4 for controlling microbial and animal pathogens in plants of the Musaceae family.

A further subject matter of the invention is therefore the use of compound I-5 for controlling microbial and animal pathogens in plants of the Musaceae family.

A further subject matter of the invention is therefore the use of compound I-6 for controlling microbial and animal pathogens in plants of the Musaceae family.

A further subject matter of the invention is therefore the use of compound I-7 for controlling microbial and animal pathogens in plants of the Musaceae family.

A further subject matter of the invention is therefore the use of compound I-8 for controlling microbial and animal pathogens in plants of the Musaceae family.

A further subject matter of the invention is therefore the use of compound I-9 for controlling microbial and animal pathogens in plants of the Musaceae family.

A further subject matter of the invention is therefore the use of compound I-10 for controlling microbial and animal pathogens in plants of the Musaceae family.

A further subject matter of the invention is therefore the use of compound I-11 for controlling microbial and animal pathogens in plants of the Musaceae family.

A further subject matter of the invention is therefore the use of compound I-12 for controlling microbial and animal pathogens in plants of the Musaceae family.

A further subject matter of the invention is therefore the use of compound I-13 for controlling microbial and animal pathogens in plants of the Musaceae family.

A further subject matter of the invention is therefore the use of compound I-14 for controlling microbial and animal pathogens in plants of the Musaceae family.

A further subject matter of the invention is therefore the use of compound I-15 for controlling microbial and animal pathogens in plants of the Musaceae family.

A further subject matter of the invention is therefore the use of compound I-16 for controlling microbial and animal pathogens in plants of the Musaceae family.

A further subject matter of the invention is therefore the use of compound I-17 for controlling microbial and animal pathogens in plants of the Musaceae family.

A further subject matter of the invention is therefore the use of compound I-18 for controlling microbial and animal pathogens in plants of the Musaceae family.

A further subject matter of the invention is therefore the use of compound I-19 for controlling microbial and animal pathogens in plants of the Musaceae family.

A further subject matter of the invention is therefore the use of compound I-20 for controlling microbial and animal pathogens in plants of the Musaceae family.

A further subject matter of the invention is therefore the use of a compound selected from the compounds according to formula (I) for controlling microbial and animal pathogens in plants of the Musaceae family.

A further subject matter of the invention is therefore the use of compound I-1 for controlling microbial and animal pathogens in plants of the genus Musa.

A further subject matter of the invention is therefore the use of compound I-2 for controlling microbial and animal pathogens in plants of the genus Musa.

A further subject matter of the invention is therefore the use of compound I-3 for controlling microbial and animal pathogens in plants of the genus Musa.

A further subject matter of the invention is therefore the use of compound I-4 for controlling microbial and animal pathogens in plants of the genus Musa.

A further subject matter of the invention is therefore the use of compound I-5 for controlling microbial and animal pathogens in plants of the genus Musa.

A further subject matter of the invention is therefore the use of compound I-6 for controlling microbial and animal pathogens in plants of the genus Musa.

A further subject matter of the invention is therefore the use of compound I-7 for controlling microbial and animal pathogens in plants of the genus Musa.

A further subject matter of the invention is therefore the use of compound I-8 for controlling microbial and animal pathogens in plants of the genus Musa.

A further subject matter of the invention is therefore the use of compound I-9 for controlling microbial and animal pathogens in plants of the genus Musa.

A further subject matter of the invention is therefore the use of compound I-10 for controlling microbial and animal pathogens in plants of the genus Musa.

A further subject matter of the invention is therefore the use of compound I-11 for controlling microbial and animal pathogens in plants of the genus Musa.

A further subject matter of the invention is therefore the use of compound I-12 for controlling microbial and animal pathogens in plants of the genus Musa.

A further subject matter, of the invention is therefore the use of compound I-13 for controlling microbial and animal pathogens in plants of the genus Musa.

A further subject matter of the invention is therefore the use of compound I-14 for controlling microbial and animal pathogens in plants of the genus Musa.

A further subject matter of the invention is therefore the use of compound I-15 for controlling microbial and animal pathogens in plants of the genus Musa.

A further subject matter of the invention is therefore the use of compound I-16 for controlling microbial and animal pathogens in plants of the genus Musa.

A further subject matter of the invention is therefore the use of compound I-17 for controlling microbial and animal pathogens in plants of the genus Musa.

A further subject matter of the invention is therefore the use of compound I-18 for controlling microbial and animal pathogens in plants of the genus Musa.

A further subject matter of the invention is therefore the use of compound I-19 for controlling microbial and animal pathogens in plants of the genus Musa.

A further subject matter of the invention is therefore the use of compound I-20 for controlling microbial and animal pathogens in plants of the genus Musa.

A further subject matter of the invention is therefore the use of compound I-1 for controlling microbial pathogens in plants of the genus Musa.

A further subject matter of the invention is therefore the use of compound I-1 for controlling fungi of the Mycosphaerella spp. family in plants of the Musaceae family.

A further subject matter of the invention is therefore the use of compound I-1 for controlling Mycosphaerella musa in plants of the Musaceae family.

A further subject matter of the invention is therefore the use of compound I-1 for controlling Mycosphaerella fijiensis anamorph: Paracercospora fijiensis in plants of the Musaceae family.

A further subject matter of the invention is therefore the use of compound I-1 for controlling Mycosphaerella musicola anamorph: Nattrassia mangiferae in plants of the Musaceae family.

A further subject matter of the invention is therefore the use of compound I-2 for controlling microbial pathogens in plants of the genus Musa.

A further subject matter of the invention is therefore the use of compound I-2 for controlling fungi of the Mycosphaerella spp. family in plants of the Musaceae family.

A further subject matter of the invention is therefore the use of compound I-2 for controlling Mycosphaerella musa in plants of the Musaceae family.

A further subject matter of the invention is therefore the use of compound I-2 for controlling Mycosphaerella fijiensis anamorph: Paracercospora fijiensis in plants of the Musaceae family.

A further subject matter of the invention is therefore the use of compound I-2 for controlling Mycosphaerella musicola anamorph: Nattrassia mangiferae in plants of the Musaceae family.

A further subject matter of the invention is therefore the use of compound I-3 for controlling microbial pathogens in plants of the genus Musa.

A further subject matter of the invention is therefore the use of compound I-3 for controlling fungi of the Mycosphaerella spp. family in plants of the Musaceae family.

A further subject matter of the invention is therefore the use of compound I-3 for controlling Mycosphaerella musa in plants of the Musaceae family.

A further subject matter of the invention is therefore the use of compound I-3 for controlling Mycosphaerella fijiensis anamorph: Paracercospora fijiensis in plants of the Musaceae family.

A further subject matter of the invention is therefore the use of compound I-3 for controlling Mycosphaerella musicola anamorph: Nattrassia mangiferae in plants of the Musaceae family.

A further subject matter of the invention is therefore the use of compound I-4 for controlling microbial pathogens in plants of the genus Musa.

A further subject matter of the invention is therefore the use of compound I-4 for controlling fungi of the Mycosphaerella spp. family in plants of the Musaceae family.

A further subject matter of the invention is therefore the use of compound I-4 for controlling Mycosphaerella musa in plants of the Musaceae family.

A further subject matter of the invention is therefore the use of compound I-4 for controlling Mycosphaerella fijiensis anamorph: Paracercospora fijiensis in plants of the Musaceae family.

A further subject matter of the invention is therefore the use of compound I-4 for controlling Mycosphaerella musicola anamorph: Nattrassia mangiferae in plants of the Musaceae family.

A further subject matter of the invention is therefore the use of compound I-5 for controlling microbial pathogens in plants of the genus Musa.

A further subject matter of the invention is therefore the use of compound I-5 for controlling fungi of the Mycosphaerella spp. family in plants of the Musaceae family.

A further subject matter of the invention is therefore the use of compound I-5 for controlling Mycosphaerella musa in plants of the Musaceae family.

A further subject matter of the invention is therefore the use of compound I-5 for controlling Mycosphaerella fijiensis anamorph: Paracercospora fijiensis in plants of the Musaceae family.

A further subject matter of the invention is therefore the use of compound I-6 for controlling microbial pathogens in plants of the genus Musa.

A further subject matter of the invention is therefore the use of compound I-6 for controlling fungi of the Mycosphaerella spp. family in plants of the Musaceae family.

A further subject matter of the invention is therefore the use of compound I-6 for controlling Mycosphaerella musa in plants of the Musaceae family.

A further subject matter of the invention is therefore the use of compound I-6 for controlling Mycosphaerella fijiensis anamorph: Paracercospora fijiensis in plants of the Musaceae family.

A further subject matter of the invention is therefore the use of compound I-7 for controlling microbial pathogens in plants of the genus Musa.

A further subject matter of the invention is therefore the use of compound I-7 for controlling fungi of the Mycosphaerella spp. family in plants of the Musaceae family.

A further subject matter of the invention is therefore the use of compound I-7 for controlling Mycosphaerella musa in plants of the Musaceae family.

A further subject matter of the invention is therefore the use of compound I-7 for controlling Mycosphaerella fijiensis anamorph: Paracercospora fijiensis in plants of the Musaceae family.

A further subject matter of the invention is therefore the use of compound I-8 for controlling microbial pathogens in plants of the genus Musa.

A further subject matter of the invention is therefore the use of compound I-8 for controlling fungi of the Mycosphaerella spp. family in plants of the Musaceae family.

A further subject matter of the invention is therefore the use of compound I-8 for controlling Mycosphaerella musa in plants of the Musaceae family.

A further subject matter of the invention is therefore the use of compound I-8 for controlling Mycosphaerella fijiensis anamorph: Paracercospora fijiensis in plants of the Musaceae family.

A further subject matter of the invention is therefore the use of compound I-9 for controlling microbial pathogens in plants of the genus Musa.

A further subject matter of the invention is therefore the use of compound I-9 for controlling fungi of the Mycosphaerella spp. family in plants of the Musaceae family.

A further subject matter of the invention is therefore the use of compound I-9 for controlling Mycosphaerella musa in plants of the Musaceae family.

A further subject matter of the invention is therefore the use of compound I-9 for controlling Mycosphaerella fijiensis anamorph: Paracercospora fijiensis in plants of the Musaceae family.

A further subject matter of the invention is therefore the use of compound I-10 for controlling microbial pathogens in plants of the genus Musa.

A further subject matter of the invention is therefore the use of compound I-10 for controlling fungi of the Mycosphaerella spp. family in plants of the Musaceae family.

A further subject matter of the invention is therefore the use of compound I-10 for controlling Mycosphaerella musa in plants of the Musaceae family.

A further subject matter of the invention is therefore the use of compound I-10 for controlling Mycosphaerella fijiensis anamorph: Paracercospora fijiensis in plants of the Musaceae family.

A further subject matter of the invention is therefore the use of compound I-11 for controlling microbial pathogens in plants of the genus Musa.

A further subject matter of the invention is therefore the use of compound I-11 for controlling fungi of the Mycosphaerella spp. family in plants of the Musaceae family.

A further subject matter of the invention is therefore the use of compound I-11 for controlling Mycosphaerella musa in plants of the Musaceae family.

A further subject matter of the invention is therefore the use of compound I-11 for controlling Mycosphaerella fijiensis anamorph: Paracercospora fijiensis in plants of the Musaceae family.

A further subject matter of the invention is therefore the use of compound I-12 for controlling microbial pathogens in plants of the genus Musa.

A further subject matter of the invention is therefore the use of compound I-12 for controlling fungi of the Mycosphaerella spp. family in plants of the Musaceae family.

A further subject matter of the invention is therefore the use of compound I-12 for controlling Mycosphaerella musa in plants of the Musaceae family.

A further subject matter of the invention is therefore the use of compound I-12 for controlling Mycosphaerella fijiensis anamorph: Paracercospora fijiensis in plants of the Musaceae family.

A further subject matter of the invention is therefore the use of compound I-13 for controlling microbial pathogens in plants of the genus Musa.

A further subject matter of the invention is therefore the use of compound I-13 for controlling fungi of the Mycosphaerella spp. family in plants of the Musaceae family.

A further subject matter of the invention is therefore the use of compound I-13 for controlling Mycosphaerella musa in plants of the Musaceae family.

A further subject matter of the invention is therefore the use of compound I-13 for controlling Mycosphaerella fijiensis anamorph: Paracercospora fijiensis in plants of the Musaceae family.

A further subject matter of the invention is therefore the use of compound I-14 for controlling microbial pathogens in plants of the genus Musa.

A further subject matter of the invention is therefore the use of compound I-14 for controlling fungi of the Mycosphaerella spp. family in plants of the Musaceae family.

A further subject matter of the invention is therefore the use of compound I-14 for controlling Mycosphaerella musa in plants of the Musaceae family.

A further subject matter of the invention is therefore the use of compound I-14 for controlling Mycosphaerella fijiensis anamorph: Paracercospora fijiensis in plants of the Musaceae family.

A further subject matter of the invention is therefore the use of compound I-15 for controlling microbial pathogens in plants of the genus Musa.

A further subject matter of the invention is therefore the use of compound I-15 for controlling fungi of the Mycosphaerella spp. family in plants of the Musaceae family.

A further subject matter of the invention is therefore the use of compound I-15 for controlling Mycosphaerella musa in plants of the Musaceae family.

A further subject matter of the invention is therefore the use of compound I-15 for controlling Mycosphaerella fijiensis anamorph: Paracercospora fijiensis in plants of the Musaceae family.

A further subject matter of the invention is therefore the use of compound I-16 for controlling microbial pathogens in plants of the genus Musa.

A further subject matter of the invention is therefore the use of compound I-16 for controlling fungi of the Mycosphaerella spp. family in plants of the Musaceae family.

A further subject matter of the invention is therefore the use of compound I-16 for controlling Mycosphaerella musa in plants of the Musaceae family.

A further subject matter of the invention is therefore the use of compound I-16 for controlling Mycosphaerella fijiensis anamorph: Paracercospora fijiensis in plants of the Musaceae family.

A further subject matter of the invention is therefore the use of compound I-17 for controlling microbial pathogens in plants of the genus Musa.

A further subject matter of the invention is therefore the use of compound I-17 for controlling fungi of the Mycosphaerella spp. family in plants of the Musaceae family.

A further subject matter of the invention is therefore the use of compound I-17 for controlling Mycosphaerella musa in plants of the Musaceae family.

A further subject matter of the invention is therefore the use of compound I-17 for controlling Mycosphaerella fijiensis anamorph: Paracercospora fijiensis in plants of the Musaceae family.

A further subject matter of the invention is therefore the use of compound I-18 for controlling microbial pathogens in plants of the genus Musa.

A further subject matter of the invention is therefore the use of compound I-18 for controlling fungi of the Mycosphaerella spp. family in plants of the Musaceae family.

A further subject matter of the invention is therefore the use of compound I-18 for controlling Mycosphaerella musa in plants of the Musaceae family.

A further subject matter of the invention is therefore the use of compound I-18 for controlling Mycosphaerella fijiensis anamorph: Paracercospora fijiensis in plants of the Musaceae family.

A further subject matter of the invention is therefore the use of compound I-19 for controlling microbial pathogens in plants of the genus Musa.

A further subject matter of the invention is therefore the use of compound I-19 for controlling fungi of the Mycosphaerella spp. family in plants of the Musaceae family.

A further subject matter of the invention is therefore the use of compound I-19 for controlling Mycosphaerella musa in plants of the Musaceae family.

A further subject matter of the invention is therefore the use of compound I-19 for controlling Mycosphaerella fijiensis anamorph: Paracercospora fijiensis in plants of the Musaceae family.

A further subject matter of the invention is therefore the use of compound I-20 for controlling microbial pathogens in plants of the genus Musa.

A further subject matter of the invention is therefore the use of compound I-20 for controlling fungi of the Mycosphaerella spp. family in plants of the Musaceae family.

A further subject matter of the invention is therefore the use of compound I-20 for controlling Mycosphaerella musa in plants of the Musaceae family.

A further subject matter of the invention is therefore the use of compound I-20 for controlling Mycosphaerella fijiensis anamorph: Paracercospora fijiensis in plants of the Musaceae family.

A further subject matter of the invention is a method of controlling microbial and animal pathogens in plants of the Musaceae family, characterized in that the plants of the Musaceae family are treated with a compound selected from the compounds according to formula (I).

A further subject matter of the invention is a method of controlling microbial and animal pathogens in plants of the Musaceae family, characterized in that the plants of the Musaceae family are treated with compound I-1.

A further subject matter of the invention is a method of controlling microbial and animal pathogens in plants of the Musaceae family, characterized in that the plants of the Musaceae family are treated with compound I-2.

A further subject matter of the invention is a method of controlling microbial and animal pathogens in plants of the Musaceae family, characterized in that the plants of the Musaceae family are treated with compound I-3.

A further subject matter of the invention is a method of controlling microbial and animal pathogens in plants of the Musaceae family, characterized in that the plants of the Musaceae family are treated with compound I-4.

A further subject matter of the invention is a method of controlling microbial and animal pathogens in plants of the Musaceae family, characterized in that the plants of the Musaceae family are treated with compound I-5.

A further subject matter of the invention is a method of controlling microbial and animal pathogens in plants of the Musaceae family, characterized in that the plants of the Musaceae family are treated with compound I-6.

A further subject matter of the invention is a method of controlling microbial and animal pathogens in plants of the Musaceae family, characterized in that the plants of the Musaceae family are treated with compound I-7.

A further subject matter of the invention is a method of controlling microbial and animal pathogens in plants of the Musaceae family, characterized in that the plants of the Musaceae family are treated with compound I-8.

A further subject matter of the invention is a method of controlling microbial and animal pathogens in plants of the Musaceae family, characterized in that the plants of the Musaceae family are treated with compound I-9.

A further subject matter of the invention is a method of controlling microbial and animal pathogens in plants of the Musaceae family, characterized in that the plants of the Musaceae family are treated with compound I-10.

A further subject matter of the invention is a method of controlling microbial and animal pathogens in plants of the Musaceae family, characterized in that the plants of the Musaceae family are treated with compound I-11.

A further subject matter of the invention is a method of controlling microbial and animal pathogens in plants of the Musaceae family, characterized in that the plants of the Musaceae family are treated with compound I-12.

A further subject matter of the invention is a method of controlling microbial and animal pathogens in plants of the Musaceae family, characterized in that the plants of the Musaceae family are treated with compound I-13.

A further subject matter of the invention is a method of controlling microbial and animal pathogens in plants of the Musaceae family, characterized in that the plants of the Musaceae family are treated with compound I-14.

A further subject matter of the invention is a method of controlling microbial and animal pathogens in plants of the Musaceae family, characterized in that the plants of the Musaceae family are treated with compound I-15.

A further subject matter of the invention is a method of controlling microbial and animal pathogens in plants of the Musaceae family, characterized in that the plants of the Musaceae family are treated with compound I-16.

A further subject matter of the invention is a method of controlling microbial and animal pathogens in plants of the Musaceae family, characterized in that the plants of the Musaceae family are treated with compound I-17.

A further subject matter of the invention is a method of controlling microbial and animal pathogens in plants of the Musaceae family, characterized in that the plants of the Musaceae family are treated with compound I-18.

A further subject matter of the invention is a method of controlling microbial and animal pathogens in plants of the Musaceae family, characterized in that the plants of the Musaceae family are treated with compound I-19.

A further subject matter of the invention is a method of controlling microbial and animal pathogens in plants of the Musaceae family, characterized in that the plants of the Musaceae family are treated with compound I-20.

A further subject matter of the invention is a method of controlling pathogens in plants of the Musaceae family, characterized in that the plants of the Musaceae family are treated with a compound selected from among the compounds according to formula (I).

A further subject matter of the invention is a method of controlling microbial pathogens in plants of the Musaceae family, characterized in that the plants of the Musaceae family are treated with compound I-1.

A further subject matter of the invention is a method of controlling microbial pathogens in plants of the Musaceae family, characterized in that the plants of the Musaceae family are treated with compound I-2.

A further subject matter of the invention is a method of controlling microbial pathogens in plants of the Musaceae family, characterized in that the plants of the Musaceae family are treated with compound I-3.

A further subject matter of the invention is a method of controlling microbial pathogens in plants of the Musaceae family, characterized in that the plants of the Musaceae family are treated with compound I-4.

A further subject matter of the invention is a method of controlling microbial pathogens in plants of the Musaceae family, characterized in that the plants of the Musaceae family are treated with compound I-5.

A further subject matter of the invention is a method of controlling microbial pathogens in plants of the Musaceae family, characterized in that the plants of the Musaceae family are treated with compound I-6.

A further subject matter of the invention is a method of controlling microbial pathogens in plants of the Musaceae family, characterized in that the plants of the Musaceae family are treated with compound I-7.

A further subject matter of the invention is a method of controlling microbial pathogens in plants of the Musaceae family, characterized in that the plants of the Musaceae family are treated with compound I-8.

A further subject matter of the invention is a method of controlling microbial pathogens in plants of the Musaceae family, characterized in that the plants of the Musaceae family are treated with compound I-9.

A further subject matter of the invention is a method of controlling microbial pathogens in plants of the Musaceae family, characterized in that the plants of the Musaceae family are treated with compound I-10.

A further subject matter of the invention is a method of controlling microbial pathogens in plants of the Musaceae family, characterized in that the plants of the Musaceae family are treated with compound I-11.

A further subject matter of the invention is a method of controlling microbial pathogens in plants of the Musaceae family, characterized in that the plants of the Musaceae family are treated with compound I-12.

A further subject matter of the invention is a method of controlling microbial pathogens in plants of the Musaceae family, characterized in that the plants of the Musaceae family are treated with compound I-13.

A further subject matter of the invention is a method of controlling microbial pathogens in plants of the Musaceae family, characterized in that the plants of the Musaceae family are treated with compound I-14.

A further subject matter of the invention is a method of controlling microbial pathogens in plants of the Musaceae family, characterized in that the plants of the Musaceae family are treated with compound I-15.

A further subject matter of the invention is a method of controlling microbial pathogens in plants of the Musaceae family, characterized in that the plants of the Musaceae family are treated with compound I-16.

A further subject matter of the invention is a method of controlling microbial pathogens in plants of the Musaceae family, characterized in that the plants of the Musaceae family are treated with compound I-17.

A further subject matter of the invention is a method of controlling microbial pathogens in plants of the Musaceae family, characterized in that the plants of the Musaceae family are treated with compound I-18.

A further subject matter of the invention is a method of controlling microbial pathogens in plants of the Musaceae family, characterized in that the plants of the Musaceae family are treated with compound I-19.

A further subject matter of the invention is a method of controlling microbial pathogens in plants of the Musaceae family, characterized in that the plants of the Musaceae family are treated with compound I-20.

### DEFINITIONS

Microbial pathogens comprise, inter alia, fungi, bacteria, protozoans, chromists and viruses which cause damage to plants or a plant part.

Fungi comprise, inter alia, Ascomycetes, Basidiomycetes, Chytridiomycetes, Deuteromycetes, Glomeromycetes, Microsporidia, Zygomycetes, and anamorph fungi.

Bacteria comprise, inter alia, Pseudomonadaceae, Rhizobiaceae, Enterobacteriaceae, Corynebacteriaceae and Streptomycetaceae.

Chromists comprise, inter alia, Oomycetes.

Animal pathogens comprise, inter alia, Arthropoda, Arachnida and Nematoda.

The Musaceae family consists, inter alia, of the following species: Musa acuminata, Musa balbisiana, Musa acuminata Colla with the varieties “Dwarf Cavendish”, “Giant Cavendish” and “Gros Michel”, Musa cavendishii Lamb. ex Paxt., Musa malaccensis Ridl., Musa angcorensis Gagnep., Musa aurantiaca, Musa balbisiana, Musa seminifera Lour., Musa banksii F. Muell., Musa basjoo, Musa cheesmanii, Musa flaviflora Simmonds, Musa griersonii, Musa itinerans, Musa laterita, Musa mannii, Musa nagensium, Musa ochracea, Musa ornata Roxb., Musa siamea, Musa sikkimensis, Musa thomsonii Noltie, Musa velutina Wendl. & Drude, Musa alinsanaya, Musa beccarii, Musa boman, Musa borneënsis, Musa bukensis, Musa campestris, Musa coccinea Andrews, Musa uranoscopos Lour, Musa exotica Valmayor, Musa fitzalanii, Musa flavida, Musa gracilis, Musa hirta Becc., Musa insularimontana Hayata, Musa jackeyi, Musa johnsii, Musa lawitiensis, Musa lolodensis, Musa maclayi, Musa monticola, Musa muluensis, Musa paracoccinea, Musa peekelii, Musa pigmaea Hotta, Musa rubra, Musa salaccensis, Musa splendida A. Chev., Musa suratii, Musa textilis: Abacá Japanese hardy or fibre banana, Musa troglodytarum, Musa tuberculata, Musa violascens, Musa ingens, Musa paradisiaca sapientm, Musa paradisiaca normali, and crosses of these species.

Examples of fungi which cause damage to plants of the Musaceae family are

### Acremonium spp.

Acrodontium simplex
Armillaria subspecies, for example Armillaria mellea, Armillaria tabescens
Botryosphaeria ribis
Cercospora hayi
Ceratocystis paradoxa anamorph: Chalara paradoxa
Cladosporium musae
Colletotrichum musae
Cordana johnstonii, Cordana musae
Curvularia eragrostidis

### Cylindrocladium spp.

Cylindrocarpon musae
Deightoniella torulosa
Drechslera musae-sapientum
Fusarium spp, for example Fusarium pallidoroseum, Fusarium solani anamorph Nectria haematococca, Fusarium oxysporum, Fusarium moniliforme teleomorph: Gibberella fujikuroi
Fusarium oxysporum Schldl.:Fr. f. sp. cubense
Guignardia musae Racib. anamorph: Phyllosticta musarum (Cooke)
Haplobasidion musae
Junghuhnia vincta
Lasiodiplodia theobromae
Leptosphaeria musarum,
Limacinula tenuis
Marasmiellus inoderma
Marasmius semiustus
Mycosphaerella spp., for example Mycosphaerella musa, Mycosphaerella fijiensis anamorph:
Paracercospora fijiensis, Mycosphaerella musicola anamorph: Nattrassia mangiferae
Pseudocercospora musae
Nattrassia mangiferae or Hendersonula toruloidea
Nectria foliicola
Nigrospora sphaerica
Pestalotiopsis leprogena
Pestalotiopsis palmarum
Pestalotiopsis disseminate
Phaeoseptoria musa
Phyllachora musicola
Pratylenchus coffeae
Pratylenchus goodeyi
Pratylenchus brachyurus
Pratylenchus reniformia
Pyricularia grisea
Ramichloridium musa, Veronaea musa, Periconiella musae

### Rhizoctonia spp.

Rosellinia bunodes
Sclerotinia sclerotiorum
Trachysphaera fruictigena
Verticillium theobromae
Uredo musae
Uromyces musae

Examples of bacteria which cause damage to plants of the Musaceae family are

Erwinia carotovora
Pseudomonas spp., for example Pseudomonas solanacearum, for example Race 1, Race 2
Xanthomonas campestris

Examples of viruses which cause damage to plants of the Musaceae family are

Banana bract mosaic virus
Banana bunchy top virus
Banana streak virus
Cucumber mosaic virus

Examples of nematodes which cause damage to plants of the Musaceae family are Radopholus spp. and Helicotylenchus spp.

The compound selected from among the compounds according to formula (I) may, if appropriate, be present in the form of mixtures of various isomeric forms which are possible, in particular stereoisomers, such as optical isomers.

The compound selected from among the compounds according to formula (I) can therefore be employed for protecting plants against attack by the abovementioned pathogens within a certain post-treatment period. The period within which protection is afforded generally extends from 1 to 10 days, preferably 1 to 7 days, after the treatment of the plants with the active substances. Depending on the form of application, the accessibility of the active substances to the plant can be controlled in a targeted manner.

The good plant tolerance of the compounds according to formula (I) at the concentrations required for controlling plant diseases permits a treatment of aerial and subterranean plant parts, of vegetative propagation material, and of the soil.

The compounds according to formula (I) are also suitable for increasing the yield, show low toxicity and are well tolerated by plants.

In the context of the present invention, an advantageous effect when applied to plants of the Musaceae family was observed.

In accordance with the invention, all plants of the Musaceae family may be treated. Plants of the Musaceae family are, in the present context, understood as meaning all plant parts and plant populations, such as desired and undesired wild plants or crop plants (including naturally occurring crop plants). Crop plants may be plants of the Musaceae family which can be obtained by traditional breeding and optimization methods or else by biotechnological and recombinant methods, or combinations of these methods, including the transgenic plants of the Musaceae family and including the plant varieties capable or not of being protected by Plant Breeders' Rights, such as, for example, Gros Michel, Cavendish, Dwarf Cavendish, Dwarf Chinese, Enano, Caturra, Giant Cavendish, Gran Enano, Grande Naine, Williams Hybrid, Valery, Robusta, Poyo, Lacatan, Pisang masak hijau, Monte cristo, Bout rond. Plant parts are intended to mean all aerial and subterranean parts and organs of the plants, such as herb, pseudostem, shoot, leaf, bract, leaf sheaths, petiole, lamina, flower and root, examples which may be mentioned being leaves, needles, stalks, stems, flowers, fruiting bodies, fruit, banana hand, bunches and seeds, and also roots, tubers, rhizomes, offshoots, suckers, secondary growth. The plant parts also include crop material and vegetative and generative propagation material, for example cuttings, tubers, rhizomes, slips and seeds.

As has already been mentioned above, all plants of the Musaceae family can be treated in accordance with the invention. In a preferred embodiment, plant species and plant varieties, and their parts, which are found in the wild or which are obtained by conventional biological breeding methods, such as hybridization, meristem cultures, micropropagation, somatic embryogenesis, direct organogenesis or protoplast fusion, are treated. In a further preferred embodiment, transgenic plants of the Musaceae family and plant varieties of the Musaceae family which have been obtained by recombinant methods, if appropriate in combination with traditional methods (genetically modified organisms), are treated, such as, for example, transformation by means of Agrobacterium or particle bombardment of embryogenic cells, and micropropagation. Plants of the Musaceae family include all plant parts as mentioned above.

It is especially preferred to treat, in accordance with the invention, plants of the Musaceae family of those plant varieties which are in each case commercially available or in use. Plant varieties are understood as meaning plants with new properties (“traits”) which have been obtained by conventional breeding, by mutagenesis or else by recombinant DNA techniques. They may be varieties, breeds, biotypes and genotypes.

Depending on the plant species or plant varieties, their location and growth conditions (soils, climate, vegetation period, nutrition), the treatment according to the invention may also result in superadditive (“synergistic”) effects. Thus, for example, reduced application rates and/or extensions of the activity spectrum and/or an increase in the activity of the substances and compositions that can be used according to the invention, better plant growth, increased tolerance to high or low temperatures, increased tolerance to drought or to water or soil salinity, increased flowering performance, easier harvesting, accelerated maturation, higher yields, better quality and/or a higher nutritional value of the harvested crops, better storability and/or processability of the harvested crops, which exceed the effects which are actually to be expected, are possible.

The treatment method according to the invention can be used for the treatment of genetically modified organisms (GMOs), for example plants or seeds. Genetically modified plants (or transgenic plants) are plants in which a heterologous gene has been integrated stably into the genome. Essentially, the term “heterologous gene” refers to a gene which is provided or assembled outside the plant and which, upon introduction into the nuclear genome, the chloroplast genome or the mitochondrial genome of the transformed plant, confers novel or improved agronomical or other properties by expressing a protein or polypeptide of interest, or by downregulating or switching off another gene, or other genes, present in the plant (for example by means of antisense technology, cosuppression technology or RNAi technology [RNA interference]). A heterologous gene which is present in the genome is also referred to as a transgene. A transgene which is defined by its specific presence in the plant genome is referred to as transformation event, or transgenic event.

Depending on the plant species or plant varieties, their location and their growth conditions (soils, climate, vegetation period, nutrition), the treatment according to the invention may also result in superadditive (“synergistic”) effects. For example, the following effects are possible, which extend beyond the effects which are actually to be expected: reduced application rates and/or a widened spectrum of action and/or an increased efficacy of the active substances and compositions which can be employed in accordance with the invention, better plant growth, increased tolerance to high or low temperatures, increased tolerance to drought or water or soil salinity, improved flowering performance, easier harvesting, accelerated maturation, higher yields, larger fruit, greater plant height, more intensive green colour of the leaf, earlier flowering, better quality and/or higher nutritional value of the harvested crops, higher sugar concentration in the fruits, better storability and/or processability of the harvested crops.

At certain application rates, the compounds according to formula (I) can also exert a strengthening effect on plants. They are therefore suitable for mobilizing the plant defence system against attack by microbial and animal pathogens. This may be one of the reasons for the increased efficacy of the combinations according to the invention, for example against fungi. Plant-strengthening (resistance-inducing) substances in the present context are also to be understood as meaning those substances or substance combinations which are capable of stimulating the plant defence system such that the treated plants, when subsequently inoculated with microbial and animal pathogens, have a considerable degree of resistance to these microbial and animal pathogens. The substances according to the invention can therefore be employed for protecting plants against attack by the above-mentioned pathogens within a certain post-treatment period. In general, the period of time over which a protective effect is achieved extends from 1 to 10 days, preferably 1 to 7 days, after the treatment of the plants with the active substances.

Plants and plant varieties of the Musaceae family which are preferably treated in accordance with the invention include all plants which contain hereditary material which confers especially advantageous, useful traits to these plants (no matter whether this has been achieved by breeding and/or biotechnology).

Plants and plant varieties of the Musaceae family which are also preferably treated in accordance with the invention are resistant to one or more biotic stress factors, i.e. these plants have an improved defence against animal and microbial pathogens such as nematodes, insects, mites, phytopathogenic fungi, bacteria, viruses and/or viroids. Those which must be mentioned by preference in this context are Musaceae which are resistant to phytopathogenic fungi or viruses.

Examples are plants of the Musaceae family transformed with human lysozyme which are resistant to Fusarium spp., to Mycosphaerella fijiens, Banana Bunchy Top Virus or Xanthomonas-campestris-resistant plants of the Musaceae family.

Plants and plant varieties of the Musaceae family which can also be treated in accordance with the invention are those plants which are resistant to one or more abiotic stress factors. The abiotic stress conditions may include for example drought, low-temperature and high-temperature conditions, osmotic stress, water-logging, increased soil salinity, increased exposure to minerals, ozone conditions, intensive light conditions, limited availability of nitrogen nutrients, limited availability of phosphorus nutrients, or shade avoidance.

Plants and plant varieties of the Musaceae family which can also be treated in accordance with the invention are those plants in which vaccines or therapeutic proteins are expressed heterologously. These include, for example, hepatitis B antigen.

Plants and plant varieties of the Musaceae family which can also be treated in accordance with the invention are those plants which are characterized by improved yield characteristics. In these plants, an increased yield may be caused by, for example, improved plant physiology, improved plant growth and improved plant development, such as water utilization efficacy, water holding efficacy, improved nitrogen utilization, increased carbon assimilation, improved photosynthesis, improved seed vigour, and accelerated maturation. The yield may furthermore be influenced by improved plant architecture (under stress and nonstress conditions), among which early flowering, control of flowering for the production of hybrid seed, seedling vigour, plant size, internode number and distance, root growth, seed size, fruit size, pod size, pod number or ear number, number of seeds per pod or ear, seed biomass, increased seed filling, reduced seed shedding, reduced pod shatter, and standing power. Further yield-related traits include seed composition such as carbohydrate content, protein content, oil content and oil composition, nutritional value, reduction of antinutritional compounds, improved processability and improved storability.

Plants of the Musaceae family that may be treated according to the invention are hybrid plants that already express the characteristics of heterosis or hybrid vigour which results generally in higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male-sterile plants and sold to growers. Male-sterile plants can sometimes (e.g. in corn) be produced by detasseling (i.e. the mechanical removal of the male reproductive organs or male flowers) but, more typically, male sterility is the result of genetic determinants in the plant genome. In that case, and especially when seed is the desired product to be harvested from the hybrid plants, it is typically useful to ensure that male fertility in hybrid plants that contain the genetic determinants responsible for male sterility is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described for Brassica species. However, genetic determinants for male sterility can also be located in the nuclear genome. Male-sterile plants can also be obtained by plant biotechnology methods such as genetic engineering. A particularly useful means of obtaining male-sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar.

Plants or plant varieties of the Musaceae family (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium, the CP4 gene of the bacterium Agrobacterium sp., the genes encoding a Petunia EPSPS, a Tomato EPSPS, or an Eleusine EPSPS. It can also be a mutated EPSPS. Glyphosate-tolerant plants can also be obtained by expressing a gene that encodes a glyphosate oxido-reductase enzyme. Glyphosate-tolerant plants can also be obtained by expressing a gene that encodes a glyphosate acetyltransferase enzyme. Glyphosate-tolerant plants can also be obtained by selecting plants containing naturally occurring mutations of the abovementioned genes.

Other herbicide-resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant of the glutamine synthase enzyme that is resistant to inhibition. One such efficient detoxifying enzyme is, for example, an enzyme encoding a phosphinothricin acetyltransferase (such as, for example, the bar or pat protein from Streptomyces species). Plants expressing an exogenous phosphinothricin acetyltransferase have been described.

Further herbicide-tolerant plants are also plants that are made tolerant to the herbicides inhibiting the enzyme hydroxyphenylpyruvate dioxygenase (HPPD). Hydroxyphenylpyruvate dioxygenases are enzymes that catalyse the reaction in which para-hydroxyphenylpyruvate (HPP) is transformed into homogentisate. Plants tolerant to HPPD inhibitors can be transformed with a gene encoding a naturally occurring resistant HPPD enzyme, or a gene encoding a mutated HPPD enzyme. Tolerance to HPPD inhibitors can also be obtained by transforming plants with genes encoding certain enzymes enabling the formation of homogentisate despite the inhibition of the native HPPD enzyme by the HPPD inhibitor. The tolerance of plants to HPPD inhibitors can also be improved by transforming plants with a gene encoding an enzyme prephenate dehydrogenase in addition to a gene encoding an HPPD-tolerant enzyme.

Further herbicide-resistant plants are plants that are made tolerant to acetolactate synthase (ALS) inhibitors. Known ALS inhibitors include, for example, sulphonylurea, imidazolinone, triazolopyrimidines, pyrimidinyloxy(thio)benzoates and/or sulphonylaminocarbonyltriazolinone herbicides. Different mutations in the ALS enzyme (also known as acetohydroxyacid synthase (AHAS)) are known to confer tolerance to different herbicides and groups of herbicides. The production of sulphonylurea-tolerant plants and imidazolinone-tolerant plants is described in international publication WO 1996/033270. Further sulphonylurea- and imidazolinone-tolerant plants are also described in for example WO 2007/024782.

Other plants which are tolerant to imidazolinone and/or sulphonylurea can be obtained by induced mutagenesis, selection in cell cultures in the presence of the herbicide, or by mutation breeding.

Plants or plant varieties of the Musaceae family (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins described online at: http://www.lifesci.sussex.ac.uk/Home/Neil_Crickmore/Bt/, or insecticidal portions thereof, e.g., proteins of the Cry protein classes Cry1 Ab, Cry1 Ac, Cry1F, Cry2Ab, Cry3Ae or Cry3Bb, or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins; or
3) a hybrid insecticidal protein comprising parts of two different insecticidal crystal proteins from Bacillus thuringiensis, such as a hybrid of the proteins of 1) above or a hybrid of the proteins of 2) above, e.g., the Cry1A.105 protein produced by corn event MON98034 (WO 2007/027777); or
4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR 604;
5) an insecticidal secreted protein from Bacillus thuringiensis or Bacillus cereus, or an insecticidal portion thereof, such as the vegetative insecticidal (VIP) proteins listed at: http://www.lifesci.sussex.ac.uk/HomeNeil_Crickmore/Bt/vip.html, e.g., proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins; or
7) a hybrid insecticidal protein comprising parts of different secreted proteins from Bacillus thuringiensis or Bacillus cereus, such as a hybrid of the proteins of 1) or a hybrid of the proteins of 2) above; or
8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT 102.

Of course, an insect-resistant transgenic plant, as used herein, also includes any plant comprising a combination of genes encoding the proteins of any one of the above classes 1 to 8. In one embodiment, an insect-resistant plant contains more than one transgene encoding a protein of any one of the above classes 1 to 8, in order to expand the range of target insect species affected or to delay insect resistance development to the plants by using different proteins insecticidal to the same target insect species but having a different mode of action, such as binding to different receptor binding sites in the insect.

Plants or plant varieties of the Musaceae family (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress tolerance plants include:
a. Plants which contain a transgene capable of reducing the expression and/or the activity of the poly(ADP-ribose)polymerase (PARP) gene in the plant cells or plants.
b. Plants which contain a stress tolerance-enhancing transgene capable of reducing the expression and/or the activity of the PARG-encoding genes of the plants or plant cells.
c. Plants which contain a stress tolerance-enhancing transgene coding for a plant-functional enzyme of the nicotinamide adenine dinucleotide salvage biosynthesis pathway including nicotinamidase, nicotinate phosphoribosyltransferase, nicotinic acid mononucleotide adenyltransferase, nicotinamide adenine dinucleotide synthetase or nicotin amide phosphoribosyltransferase.

### Application Forms

The treatment according to the invention of the plants of the Musaceae family and plant parts and of the propagation material with a compound selected from among the compounds according to formula (I) is carried out directly or by acting on their environment, habitat or store by the customary treatment methods, for example by dipping, spraying, atomizing, nebulizing, scattering, painting on, injecting.

In an especially preferred embodiment of the present invention, a compound selected from among the compounds according to formula (I) or their formulations is used for application in the form of granules, for the treatment of vegetative propagation material, or for rhizome or foliar application.

Depending on its respective physical and/or chemical properties, the compound selected from among the compounds according to formula (I) can be converted into the customary formulations, such as solutions, emulsions, suspensions, powders, foams, pastes, granules, sachets, aerosols, microencapsulations in polymeric substances, and ULV cold- and hot-fogging formulations.

These formulations are prepared in a known manner, for example by mixing the compounds according to formula (I) with extenders, that is to say liquid solvents, pressurized liquefied gases and/or solid carriers, optionally with the use of surfactants, that is emulsifiers and/or dispersants and/or foam formers. If water is used as the extender, it is possible for example also to use organic solvents as cosolvents. Liquid solvents which are suitable in the main are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons, such as cyclohexane or paraffins, for example mineral oil fractions, alcohols such as butanol or glycol, and their ethers and esters, ketones such as acetone, methyl ethyl ketone, methyl isobutyl ketone or cyclohexanone, strongly polar solvents such as dimethylformamide and dimethyl sulphoxide, and water, and also mineral, animal and vegetable oils such as, for example, palm oil or other plant seed oils. Liquefied gaseous extenders or carriers are understood as meaning those liquids which are gaseous at normal temperature and under normal pressure, for example aerosol propellants such as halohydrocarbons and butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as highly disperse silica, alumina and silicates. Suitable solid carriers for granules are: for example crushed and fractionated natural rocks such as calcite, pumice, marble, sepiolite, dolomite, and synthetic granules of inorganic and organic meals, and granules of organic material such as sawdust, coconut shells, maize cobs and tobacco stalks. Emulsifiers and/or foam formers which are suitable are: for example nonionic, cationic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, and protein hydrolysates. Suitable dispersants are: for example, lignosulphite waste liquors and methylcellulose.

Adhesives such as carboxymethylcellulose, natural and synthetic polymers in the form of powders, granules or latices, such as gum arabic, polyvinyl alcohol, polyvinyl acetate, and natural phospholipids such as cephalins and lecithins, and synthetic phospholipids, may be used in the formulations. Further additives may be mineral and vegetable oils.

It is possible to use colorants such as inorganic pigments, for example iron oxide, titanium oxide, Prussian Blue, and organic dyestuffs, such as alizarin, azo and metal phthalocyanine dyestuffs, and trace nutrients, such as salts of iron, manganese, boron, copper, cobalt, molybdenum and zinc.

In general, the formulations contain between 0.1 and 95% by weight of active substance, preferably between 0.5 and 90%.

The control of microbial and animal pathogens by treating the vegetative propagation material of plants has been known for a long time and is the subject of continuous improvements. However, the treatment of vegetative propagation material involves a series of problems which cannot always be solved in a satisfactory manner. Thus, it is desirable to develop methods for protecting the vegetative propagation material and the germinating plant which do away with, or at least markedly reduce, the additional application of plant protection products after planting or after emergence of the plants. It is furthermore desirable to optimize the amount of the active substance employed such that the vegetative propagation material and the germinating plant are protected the best possible from attack by microbial pathogens without, however, damaging the plant itself by the active substance employed. In particular, methods for the treatment of vegetative propagation material should also take into consideration the intrinsic properties of transgenic plants in order to achieve an optimal protection of the vegetative propagation material and the germinating plant while keeping the application rate of plant protection products as low as possible.

The present invention therefore relates in particular also to a method of protecting vegetative propagation material and germinating plants from attack by microbial and animal pathogens, by treating the seed and the vegetative propagation material with a composition according to the invention.

The invention also relates to the use of the compositions according to the invention for the treatment of vegetative propagation material for protecting the vegetative propagation material and the germinating plant from microbial and animal pathogens.

One of the advantages of the present invention is that, owing to the special systemic properties of the compositions according to the invention, the treatment of the vegetative propagation material with these compositions protects not only the vegetative propagation material itself, but also the plants which it gives rise to after planting, from microbial and animal pathogens. In this manner, the immediate treatment of the crop at the time of planting, or shortly thereafter, can be dispensed with.

Another advantage is that the compositions according to the invention can be employed in particular also in transgenic vegetative propagation material.

The compositions according to the invention are suitable for protecting vegetative propagation material of any plant variety which is employed in agriculture, in the greenhouse, in forests or in horticulture. In particular, this is vegetative propagation material of Musaceae.

Within the scope of the present invention, the composition according to the invention is applied to the vegetative propagation material either alone or in a suitable formulation. Preferably, the vegetative propagation material is treated in a state in which it is sufficiently stable such that no damage occurs during the treatment. In general, the vegetative propagation material can be treated at any point in time between harvesting and planting out. Usually, vegetative propagation material is used which has been separated from the plant and freed from cobs, shells, stalks, coats, hairs or fruit flesh.

When treating the vegetative propagation material, care must be taken in general that the amount of the composition according to the invention, and/or of further additives, applied to the vegetative propagation material is chosen such that the germination of the vegetative propagation material is not adversely affected, or that the plant which it gives rise to is not damaged. This must be considered in particular in the case of active substances which, at certain application rates, may have phytotoxic effects.

The compositions according to the invention can be applied directly, that is to say without containing further components and without having been diluted. As a rule, it is preferable to apply the compositions to the vegetative propagation material in the form of a suitable formulation. Suitable formulations and methods for the treatment of seed and of vegetative propagation material are known to the skilled worker.

The compounds which can be used in accordance with the invention and which are selected from among compounds according to formula (I) can be converted into the customary formulations, such as solutions, emulsions, suspensions, powders, foams and ULV formulations.

These formulations are prepared in the known manner by mixing the compounds selected from among the compounds of the formula (I) with customary additives, such as, for example, customary extenders and also solvents or diluents, colorants, wetters, dispersants, emulsifiers, antifoams, preservatives, secondary thickeners, adhesives, gibberellins, mineral and vegetable oils, and also water.

Colorants which may be present in the formulations which can be used in accordance with the invention are all colorants which are customary for such purposes. In this context, both pigments, which are sparingly soluble in water, and dyes, which are soluble in water, may be used. Examples which may be mentioned are the colorants known by the names Rhodamin B, C.I. Pigment Red 112 and C.I. Solvent Red 1.

Wetters which may be present in the formulations which can be used in accordance with the invention are all substances which are customary for formulating agrochemical active substances and which promote wetting. Alkylnaphthalenesulphonates, such as diisopropyl- or diisobutylnaphthalenesulphonates, may preferably be used.

Suitable dispersants and/or emulsifiers which may be present in the formulations which can be used in accordance with the invention are all nonionic, anionic and cationic dispersants which are conventionally used for the formulation of agrochemical active substances. The following may be used by preference: nonionic or anionic dispersants or mixtures of nonionic or anionic dispersants. Suitable nonionic dispersants which may be mentioned are, in particular, ethylene oxide/propylene oxide block polymers, alkylphenol polyglycol ethers and tristyrylphenol polyglycol ethers and their phosphated or sulphated derivatives. Suitable anionic dispersants are, in particular, lignosulphonates, salts of polyacrylic acid, and arylsulphonate/formaldehyde condensates.

Antifoams which may be present in the formulations which can be used in accordance with the invention are all foam-inhibitor substances which are conventionally used for the formulation of agrochemical active substances. Silicone antifoams and magnesium stearate may be used by preference.

Preservatives which may be present in the formulations which can be used in accordance with the invention are all substances which can be employed for such purposes in agrochemical compositions. Examples which may be mentioned are dichlorophene and benzyl alcohol hemiformal.

Secondary thickeners which may be present in the formulations which can be used in accordance with the invention are all substances which can be employed for such purposes in agrochemical compositions. Cellulose derivatives, acrylic acid derivatives, xanthan, modified clays and highly disperse silica are preferably suitable.

Adhesives which may be present in the formulations which can be used in accordance with the invention are all customary binders which can be used in mordants. Polyvinylpyrrolidone, polyvinyl acetate, polyvinyl alcohol and tylose may be mentioned by preference.

Gibberellins which may be present in the formulations which can be used in accordance with the invention are preferably Gibberellin A1, Gibberellin A3 (gibberellic acid), Gibberellin A4, Gibberellin A7. Especially preferred is gibberellic acid.

The gibberellins are known (cf. R. Wegler “Chemie der Pflanzenschutz- and Schädlingsbekämpfungsmittel” [Chemistry of plant protection and pesticide agents], volume 2, Springer Verlag, Berlin-Heidelberg-New York, 1970, pages 401-412).

The formulations which can be used in accordance with the invention can be employed, for the treatment of various types of seed, either directly or after previously having been diluted with water. Thus, the concentrates or the preparations obtainable therefrom by dilution with water can be employed for dressing the seed of Musaceae. The formulations which can be used in accordance with the invention, or their diluted preparations, can also be employed for treating the vegetative propagation material of transgenic plants. Here, additional synergistic effects may also occur in combination with the substances formed by expression.

The application rate of the formulations which can be used in accordance with the invention can be varied within a substantial range. It depends on the respective active substance content in the formulations, and on the vegetative propagation material. As a rule, the application rates of active substance are between 0.001 and 50 g per kilogram of vegetative propagation material, preferably between 0.01 and 15 g per kilogram of vegetative propagation material.

### Mixtures

A compound selected from among the compounds according to formula (I) can be employed as such or, in formulations, also in a mixture with known fungicides, bactericides, acaricides, nematicides, herbicides, insecticides, safeners, soil-improvement products or products for reducing plant stress, for example Myconate, in order to widen the spectrum of action or to prevent the development of resistance, for example. In many cases, this engenders synergistic effects, that is to say the efficacy of the mixture exceeds the efficacy of the individual components.

In accordance with the invention, the term “mixture” means various combinations of at least two of the abovementioned active substances which are possible, such as, for example, ready mixes, tank mixes (which is understood as meaning spray slurries prepared from the formulations of the individual active substances by combining and diluting prior to the application) or combinations of these (for example, a binary ready mix of two of the abovementioned active substances is made into a tank mix by using a formulation of the third individual substance). According to the invention, the individual active substances may also be employed sequentially, i.e. one after the other, at a reasonable interval of a few hours or days, in the case of the treatment of seed for example also by applying a plurality of layers which contain different active substances. Preferably, it is immaterial in which order the individual active substances can be employed.

The compounds according to formula (I) can be employed as such, in the form of their formulations or the use forms prepared therefrom, such as ready-to-use solutions, suspensions, wettable powders, pastes, soluble powders, dusts and granules. They are applied in the customary manner, for example by pouring, spraying, atomizing, scattering, dusting, foaming, painting on and the like. It is furthermore possible to apply the compounds according to formula (I) by the ultra-low-volume method or to inject the active substance preparation, or the active substance itself, into the soil. The vegetative propagation material of the plants may also be treated.

When employing a compound selected from among the compounds according to formula (I), the application rates may be varied within a substantial range, depending on the type of application. In the treatment of plant parts, the application rates of active substance are generally between 0.1 and 10 000 g/ha, preferably between 10 and 1000 g/ha. In the treatment of vegetative propagation material, the application rates of active substance are generally between 0.001 and 50 g per kilogram of vegetative propagation material, preferably between 0.01 and 10 g per kilogram of vegetative propagation material. In the treatment of the soil, the application rates of active substance are generally between 0.1 and 10 000 g/ha, preferably between 1 and 5000 g/ha.

The examples which follow are intended to illustrate the invention, but without imposing any limitation.

### Examples

If the banana disease caused by the black Sigatoka fungus Mycosphaerella figiensis is not controlled, the latter can destroy the banana leaves and greatly reduce the yield. To control Sigatoka, commercially available fungicides are used which are usually applied to banana plants by foliar application.

Isotianil usually stimulates treated plants in such a way that they develop a resistance to penetrating pathogens, this mode of action being referred to as systemic acquired resistance (SAR).

### Methods:

It was intended to determine whether isotianil is capable of controlling the black Sigatoka infection with reference to studies carried out on Cavendish bananas in Devao del Norte in the southern Philippines.

Compound I-2 as defined above was formulated as a suspension concentrate formulation (200 SC) with Banol mineral oil and water in a ratio of 0.5 l of compound I-2 (200 SC), 5 l of oil and 74 l of water. The emulsifier used was 0.05 l of Lutensol so as to maintain the oil/water mixture as a stable emulsion.

After the formulation procedure, the mixture was sprayed onto banana trees using engine-driven spray mist applicators which applied a total volume of 80 l/ha.

This was followed by eight applications at seven-day intervals between Aug. 28 and Oct. 16, 2008. The isotianil application rate was 50, 75 and 100 g of a.i./ha, respectively.

For comparison with the isotianil plots, one plot was left untreated, and a further plot was sprayed with Sico (difenconazole 250 SC), a commercially available fungicide which is used for controlling black Sigatoka. Sico was sprayed together with Banol oil and Lutensol at an application rate of 100 g of a.i./ha, as above.

Each plot consisted of two banana plants at the BBCH growth stage 1056-1100. Each treatment consisted of three replications.

After the application, the disease level on the banana leaves was determined according to several parameters which are defined by the “Stover method” (Stover, 1971 R. H. Stover, A proposed international scale for estimating intensity of banana leaf spot, Tropical Agriculture).

Youngest infected leaf (YLI): This parameter records which leaf of the plant was the youngest leaf to show initial symptoms of Sigatoka infection. This is important since this has a direct relationship with the degree of infection, since the youngest leaves are infected last. Under the test conditions, the plants produce approximately one new leaf per week.

The severity of the disease (SEV) describes the direct percentage of visual disease on the plant.

### Results:

The youngest infected leaf and the severity of the disease were determined weekly after the first application. The data hereinbelow describe the results of the last determination measured at the end of the experiment, on Oct. 23, 2008. After the weekly determination, moreover, the data were compiled in the form of a graph, and the area under the disease progress curve (AUDPC) was calculated over the complete study period and is listed hereinbelow. Moreover, % severity was calculated as described by ABBOTT.

| | YLI last | YLI | SEV last | SEV | SEV |
|---|---|---|---|---|---|
| | determ. | AUDPC | determ. | AUDPC | ABBOTT |
| Untreated | 3 | 183 | 19.2 | 580 | |
| SICO 100 g | 4 | 221 | 7.1 | 318 | 63 |
| Compound I-2 | 4 | 223 | 5.3 | 314 | 72.4 |
| (200 SC) 50 g | | | | | |
| Compound I-2 | 4 | 224 | 5 | 285 | 74 |
| (200 SC) 75 g | | | | | |
| Compound I-2 | 4 | 119 | 5.3 | 313 | 72.6 |
| (200 SC) 100 g | | | | | |

1. A method for controlling microbial and animal pathogens in plants of the Musaceae family comprising contacting the plants or their environment with a compound of formula (I) 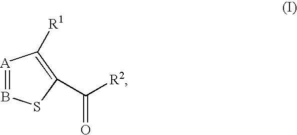
where
A is nitrogen or C-Hal,
B is nitrogen or C-Hal,
R¹ is hydrogen, halogen, cyano, C₁-C₆-alkyl, C₂-C₆-alkenyl, C₃-C₆-cycloalkyl, phenyl, C₁-C₆-alkyl which is substituted by Hal or cyano, C₂-C₆-alkenyl which is substituted by Hal or cyano, C₃-C₆-cycloalkyl which is substituted by Hal or cyano, or phenyl which is substituted by cyano, halogen, alkoxy,
R² is hydroxyl, C₁-C₆-thioalkyl, C₁-C₆-aminoalkyl, C₁-C₆-alkoxy, phenoxy, aniline,
or is C₁-C₆-alkoxy which is substituted by cyano, halogen, C₁-C₆-alkyl, C₁-C₆-alkoxy and/or C₁-C₆-alkylcarbonyl,
or is phenoxy which is substituted by cyano, halogen, C₁-C₆-alkoxy, C₁-C₆-alkylamino, C₁-C₆-alkylcarbonyl, formyl, C₁-C₆-alkyl, C₁-C₆-alkoxy, C₁-C₆-alkylcarbonyl and/or C₁-C₆-alkoxycarbonyl or is aniline which is substituted by cyano, halogen, C₁-C₆-alkyl, C₁-C₆-alkoxy, C₁-C₆-alkylamino, C₁-C₆-dialkylamino and/or C₁-C₆-alkylcarbonyl, and
Hal is halogen.

2. The method according to claim 1, wherein the compound of formula (I) is compound I-1, wherein A is N, B is N, R¹ is CH₃ and R² is 3-chloro-4-methylaniline.

3. The method according to claim 1, wherein the compound of formula (I) is compound I-2, wherein A is C-Hal, B is N, R¹ is Cl, R² is 2-cyanoaniline and Hal is Cl.

4. The method according to claim 1, wherein the compound of formula (I) is compound I-3, wherein A is N, B is N, R¹ is CH₃ and R² is OH.

5. The method according to claim 1, wherein the compound of formula (I) is compound I-4, wherein A is C-Hal, B is N, R¹ is Cl, R² is OH and Hal is Cl.

6. The method according to claim 1, wherein the compound of formula (I) is compound I-5, wherein A is N, B is N, R¹ is cyclopropyl and R² is 3-chloro-4-methylaniline.

7. A method for controlling animal pathogens in plants of the Musaceae family comprising contacting the plants or their environment with a compound I-2 of formula (I) according to claim 1, wherein A is C-Hal, B is N, R¹ is Cl, R² is 2-cyanoaniline and Hal is Cl.

8. A method for controlling fungi of the Mycosphaerella spp. family in plants of the Musaceae family comprising contacting the plants or their environment with a compound I-2 of formula (I) according to claim 1, wherein A is C-Hal, B is N, R¹ is Cl, R² is 2-cyanoaniline and Hal is Cl.

9. A method for controlling Mycosphaerella musa in plants of the Musaceae family comprising contacting the plants or their environment with a compound I-2 of formula (I) according to claim 1, wherein A is C-Hal, B is N, R¹ is Cl, R² is 2-cyanoaniline and Hal is Cl.

10. A method for controlling Mycosphaerella fijiensis anamorph: Paracercospora fijiensis in plants of the Musaceae family comprising contacting the plants or their environment with a compound I-2 of formula (I) according to claim 1, wherein A is C-Hal, B is N, R¹ is Cl, R² is 2-cyanoaniline and Hal is Cl.

11. A method for controlling Mycosphaerella musicola anamorph: Nattrassia mangiferae in plants of the Musaceae family comprising contacting the plants or their environment with a compound I-2 of formula (I) according to claim 1, wherein A is C-Hal, B is N, R¹ is Cl, R² is 2-cyanoaniline and Hal is Cl.

12. The method according to claim 3, wherein the plants are transgenic plants.

13. (canceled)
